(19) United States
(12) Patent Application Publication
(10) Pub. No.: US 2012/0119542 A1
(43) Pub. Date: May 17, 2012

(54) CAR BODY WITH REINFORCING STRUCTURE

(75) Inventors: Udo MILDNER, Limburg (DE); Karsten BOHLE, Bad Schwalbach (DE)

(73) Assignee: GM GLOBAL TECHNOLOGY OPERATIONS LLC, Detroit, MI (US)

(21) Appl. No.: 13/294,215

(22) Filed: Nov. 11, 2011

(30) Foreign Application Priority Data
Nov. 12, 2010 (DE) 102010051271.0

(51) Int. Cl. B62D 25/08

(52) U.S. Cl. 296/187.09

(57) ABSTRACT

A car body is provided with a longitudinal beam that extends in essentially the longitudinal direction of the vehicle and with a first reinforcing element that borders thereon in the longitudinal direction and an end section of which that faces away from the longitudinal beam that is supported on a floor structure of the car body by a second reinforcing element.

### CROSS-REFERENCE TO RELATED APPLICATION

This application claims priority to German Patent Application No. 102010051271.0, filed Nov. 12, 2010, which is incorporated herein by reference in its entirety.

### TECHNICAL FIELD

The technical field pertains to a car body, particularly a car body front section with structure-reinforcing means in the transition area between a front frame and the vehicle dashboard.

### BACKGROUND

Integral car bodies typically feature a front frame that, referred to the driving direction of the motor vehicle, is arranged in front of the passenger compartment and has lateral front longitudinal beams that extend essentially in the longitudinal direction of the vehicle. In the region of a dashboard that separates the passenger compartment from the engine compartment arranged in front thereof, the longitudinal beams are structurally connected, i.e., connected in a load-transmitting fashion, to a dashboard cross member, a lateral dashboard sheet and/or lateral sill boards that extend in essentially the longitudinal direction of the vehicle.

A wheel housing with a wheel housing sheet or wheel arch sheet is furthermore provided in the aforementioned transition area. The wheel housing sheet is typically curved inward. In order to structurally reinforce the front frame connection, it is typically required to provide a reinforcing structure, e.g., in the form of a reinforcing sheet that is adapted to the contour of the wheel arch or the dashboard sheet.

For example, DE 199 26 352 B4 discloses a car body shell of a motor vehicle with a front section structure featuring lower front longitudinal beams, as well as upper longitudinal beams, that are respectively followed by a McPherson strut console and run into the lateral A-columns, the bottom of which is connected to the lateral longitudinal sill boards of the passenger compartment. In this case, both sides of the vehicle are respectively provided with an interlocked bracing arrangement that extends obliquely downward in the vertical direction of the vehicle—as well as rearward in the longitudinal direction of the vehicle, between the upper longitudinal beam and the assigned lateral longitudinal sill board. In this case, the longitudinal beam, the sill board, the A-column extension and the front longitudinal beam essentially lie in a common plane that is aligned in the longitudinal direction of the vehicle and in the vertical direction of the vehicle.

In contrast, at least one objective is to improve the structural rigidity of a car body, particularly in the transition area between the front frame and the dashboard, and of increasing the resistance, in particular, to forces acting thereupon laterally. At least another objective is to minimize the overall weight of the car body and improving the structural rigidity of the car body in the lateral direction of the vehicle, as well as the intrusion behavior of the car body, in particular, during a laterally offset frontal impact. In addition, other objectives, desirable features and characteristics will become apparent from the subsequent summary and detailed description, and the appended claims, taken in conjunction with the accompanying drawings and this background.

### SUMMARY

The car body comprises at least one front longitudinal beam that essentially extends in the longitudinal direction of the vehicle and a first reinforcing element that borders on the front longitudinal beam in the longitudinal direction. The reinforcing element primarily serves for supporting the longitudinal beam on the dashboard structure of the car body in this case and for this purpose may at least sectionally extend outward in the lateral direction of the vehicle, particularly with its end section that faces away from the longitudinal beam.

A second reinforcing element is arranged on the first reinforcing element. The second reinforcing element serves for downwardly supporting the first reinforcing element, in particular, on a floor structure of the car body. Consequently, an end section of the first reinforcing element that faces away from the longitudinal beam is supported on the floor structure of the car body via the second reinforcing element. This type of support is preferably realized laterally offset to the longitudinal beam or to a longitudinal beam extension or front frame extension bordering on the longitudinal beam in the longitudinal direction of the vehicle.

Although the following description merely refers to one front longitudinal beam, the car body typically features two lateral longitudinal beam structures that are realized symmetric to one another. It goes without saying that the description of the reinforcing structures and reinforcing elements refers to both longitudinal beams.

According to an embodiment, the first reinforcing element extends in essentially the longitudinal direction (x) of the vehicle in the region of an end section that faces the front longitudinal beam while it extends in essentially the lateral direction (y) of the vehicle, but at least obliquely to the longitudinal direction of the vehicle, in the region of an end section that faces away from the front longitudinal beam and faces the second reinforcing element. The first reinforcing element preferably protrudes outward and therefore projects from the longitudinal beam or from a front frame extension that typically borders on the longitudinal beam in the longitudinal direction of the vehicle.

Since the second reinforcing element stabilizes, in particular, the end section of the first reinforcing element that protrudes outward in the lateral direction of the vehicle, the structural rigidity of the car body can be increased, particularly in the transition area between the front longitudinal beam and the vehicle dashboard. The outwardly protruding shape of the first reinforcing element also makes it possible, in particular, to achieve an improved lateral impact behavior and a reduced degree of lateral intrusion or deformation of the car body during a lateral impact. This reinforcement may also prove advantageous during a laterally offset frontal impact.

Due to the described longitudinal frame arrangement, foot well intrusions in the longitudinal direction of the vehicle can also be reduced and an improved load introduction or load distribution into the car body can be achieved in the longitudinal direction of the vehicle, particularly during a laterally offset frontal impact.

In an additional embodiment, it is furthermore proposed that the first reinforcing element curves outward in the lateral direction of the vehicle in accordance with the contour of a wheel arch sheet or wheel housing sheet. The first reinforcing element is preferably realized in the form of a C-shaped profile element and can be closed by means of the wheel housing sheet. The first reinforcing element of C-shaped cross-section may feature mounting flanges that preferably protrude outward on both of its limbs. The reinforcing element adjoins the wheel housing sheet with said mounting flanges in its installation position and may be rigidly connected thereto with the aid of said flange sections, e.g., by means of welding or similar joining the connecting techniques. In this case, the wheel housing sheet may furthermore act as a closing sheet for the C-shaped cross-sectional profile of the first reinforcing element.

According to another embodiment, the second reinforcing element may be downwardly supported referred to the vertical direction (z) of the vehicle and/or outwardly supported referred to the lateral direction (y) of the vehicle on a lateral sill board, particularly on an inside or inner lateral sill board sheet of the car body. In this case, the lateral sill board forms a component of the floor structure of the car body that supports the second reinforcing element. The second reinforcing element also may be adapted to the contour of the wheel arch sheet comparably to the first reinforcing element and be supported on the wheel arch sheet in its installation position. The second reinforcing element may act, in particular, as a cross member for the wheel arch sheet or for the dashboard region of the car body.

According to another embodiment, the front longitudinal beam transforms into an oblique, downwardly extending front frame extension opposite to the driving direction of the vehicle. In this case, the front frame extension forms an intermediate piece of sorts referred to a rear longitudinal beam or rear frame that is arranged behind the intermediate piece referred to the driving direction. In this respect, the front longitudinal beam, the front frame extension and the rear longitudinal beam form a longitudinal beam structure of the car body that extends in essentially the longitudinal direction (x) of the vehicle. The first, outwardly protruding reinforcing element lies above the front frame extension that extends obliquely downward. It is proposed, in particular, that the first reinforcing element lies at about the same height as the front longitudinal beam, in particular, in order to support the front longitudinal beam on the dashboard structure of the car body.

According to another embodiment, the second reinforcing element is supported in the vertical direction (z) of the vehicle on a cross member structure on the side of the floor with its lower end section. Between the lateral sill board and the front frame extension, the cross member structure preferably extends in essentially the lateral direction (y) of the vehicle or obliquely thereto. On its underside, said cross member structure may furthermore be provided with receptacle points, particularly with so-called main receptacle bores, in order to allow a defined accommodation and transport of the car body, particularly during the course of its production process.

The cross member structure may furthermore provide a receptacle or reinforcement for a lifting jack. The outwardly protruding region of the first reinforcing element can also be downwardly supported and correspondingly reinforced by means of the cross member structure that essentially extends in the lateral direction (y) of the vehicle and the second reinforcing element supported thereon.

Since the first reinforcing element, the second reinforcing element and the cross member structure that downwardly supports the second reinforcing element lie, referred to the lateral direction (y) of the vehicle, outside the longitudinal beam structure formed by the longitudinal beam and the front frame extension, the structural rigidity and the dimensional stability of the car body can be increased, particularly when forces act in the lateral direction of the vehicle, and the lateral impact or lateral intrusion behavior of the car body can be correspondingly improved. In this respect, it is proposed, in particular, that the first and the second reinforcing element form a coherently designed frame structure together with the front longitudinal beam, the front frame extension and the cross member structure on the side of the floor. Any deformation forces that act upon the car body externally and laterally can be taken up, in particular, by the reinforcing elements and deflected into the front frame extension, as well as into the front longitudinal frame. Depending on the direction of the effect of deformation forces, they can be taken up in a parallelogram-like fashion in the frame structure formed by the reinforcing elements, the front longitudinal beam, the front frame extension and the cross member structure on the side of the floor and deflected into the supporting structural components of the car body.

According to another embodiment, the second reinforcing element features a surface section that is realized in the form of a resting platform. This surface section is supported on a floor sheet and/or on the lateral sill board of the car body on one end and, referred to the vertical direction of the vehicle, extends obliquely upward and forward in the driving direction. In this case, this surface section may form an oblique, upwardly extending resting platform for a foot of the driver of the motor vehicle. Consequently, the second reinforcing element can also fulfill a comfort function for the vehicle occupants. The inclination of the surface section extending between the first reinforcing element and the floor sheet or the lateral sill board may, in particular, be adapted to the comfort of the occupants.

In this context, it is furthermore proposed that the surface section of the second reinforcing element that is realized in the form of a resting platform for a foot of the vehicle occupant borders on the underside of the first reinforcing element and/or on the wheel housing sheet with its end section that faces away from the floor sheet or the lateral sill board. The surface section of the second reinforcing element may also feature at least one structure-reinforcing bead. This bead may extend, for example, in the longitudinal direction of the respective surface section. The structural rigidity of the surface section can be increased with one or more beads. Due to the utilization of beads, comparatively thick-walled sheet metal components can be replaced with sheet metal components that have relatively thin walls, but are provided with beads, such that a reduction of the overall weight of the car body and therefore also the vehicle can be achieved.

According to another embodiment, the second reinforcing element features two surface sections that are essentially realized plane, but aligned angular to one another. In this case, both surface sections are essentially realized plane, but extend in different directions and therefore can, in principle, increase the structural rigidity of the second reinforcing element.

According to another embodiment, it is furthermore proposed that the second reinforcing element features at least one flange section, preferably several flange sections, over nearly its entire outer circumference in order to be connected to adjoining car body components. Due to these approximately peripheral flange sections, the second reinforcing element can almost directly border on adjoining car body components such as, for example, the first reinforcing element, a lateral sill board, a lateral dashboard, a wheel arch sheet, a cross member structure on the side of the floor and/or a floor sheet in the region of its outer contours and be respectively connected to these components in an inseparable fashion. Common joining techniques as they are conventionally used in the construction of car bodies such as, e.g., spot welding or laser welding, as well as bonding operations, riveting and clinching, may be optionally utilized for connecting the second reinforcing element, as well as all other car body components.

According to another embodiment, it is furthermore proposed to arrange the second reinforcing element in such a way referred to the longitudinal direction (x) of the vehicle and/or referred to the vertical direction (z) of the vehicle that it at least sectionally overlaps the first reinforcing element. The second reinforcing element may feature, e.g., an upwardly protruding extension, by means of which it at least sectionally protrudes over the cross-sectional profile of the first reinforcing element and preferably is positioned in front of this first reinforcing element referred to the driving direction of the vehicle. Since the second reinforcing element not only protrudes toward and is supported on the first reinforcing element from below, but also in the longitudinal direction of the vehicle, the second reinforcing element can fulfill a brace-like function in the longitudinal direction of the vehicle and in the vertical direction of the vehicle.

According to another embodiment, a motor vehicle such as, in particular, a passenger car with a car body of the above-described type is proposed.

### BRIEF DESCRIPTION OF THE DRAWINGS

The present invention will hereinafter be described in conjunction with the following drawing figures, wherein like numerals denote like elements, and:

FIG. 1 shows a perspective, isolated representation of the second reinforcing element;

FIG. 2 shows a perspective representation according to FIG. 1 of an installation situation in relation to the longitudinal beam and the front frame extension bordering thereon;

FIG. 3 shows another perspective view of a car body beam structure;

FIG. 4 shows an illustration according to FIG. 3 with a floor sheet;

FIG. 5 shows an enlarged representation of the second reinforcing element of FIG. 4;

FIG. 6 shows another illustration of the reinforcing element of FIG. 5 with an inner lateral sill board sheet laterally bordering thereon;

FIG. 7 shows a cross section along the line A-A in FIG. 2;

FIG. 8 shows a cross section along the line B-B in FIG. 2;

FIG. 9 shows a perspective representation of another embodiment of the front frame support; and

FIG. 10 shows a cross section through the support structure along the line A-A in FIG. 9.

### DETAILED DESCRIPTION

The following detailed description is merely exemplary in nature and is not intended to limit application and uses. Furthermore, there is no intention to be bound by any theory presented in the preceding background or summary or the following detailed description.

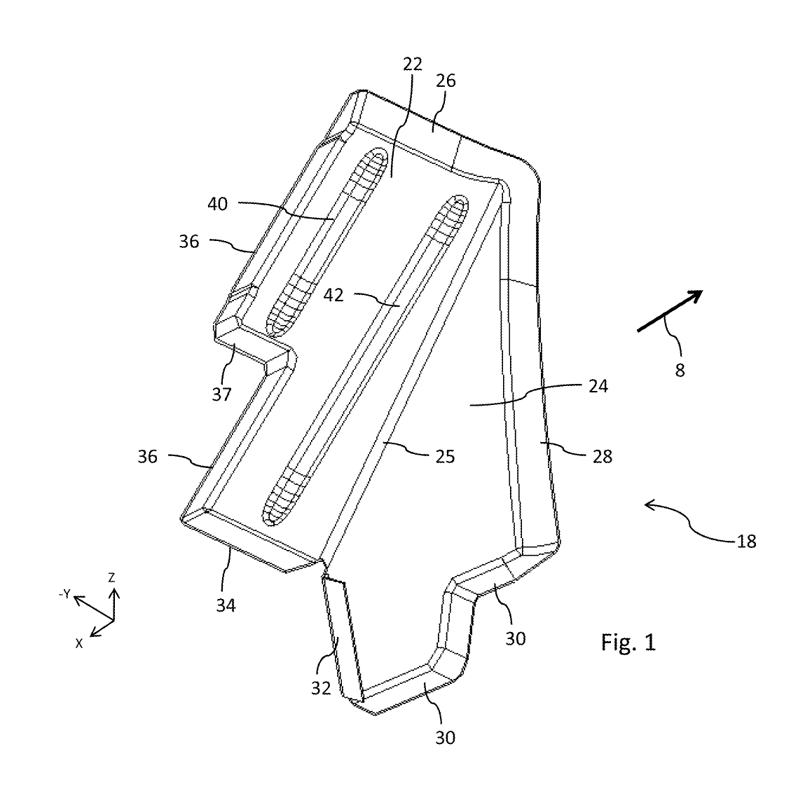

The second reinforcing element 18 that is illustrated in an isolated fashion in FIG. 1 features two essentially plane surface sections 22, 24 that are arranged angular to one another. The surface normal of the lateral surface section 24 extends in essentially the lateral direction (y) of the vehicle while the surface normal of the other surface section 22 lies in the x-z plane formed by the vertical direction (z) of the vehicle and the longitudinal direction (x) of the vehicle. The surface sections 22, 24 furthermore transform into one another in the form of an essentially straight folding or bending line 25. The surface section 22 is also provided with two reinforcing beads 40, 42 and acts as a foot resting sheet for the clutch foot of the driver of the motor vehicle. In this respect, the surface section 22 extends obliquely upward from a lower mounting flange 34 and is inclined forward in the driving direction 8.

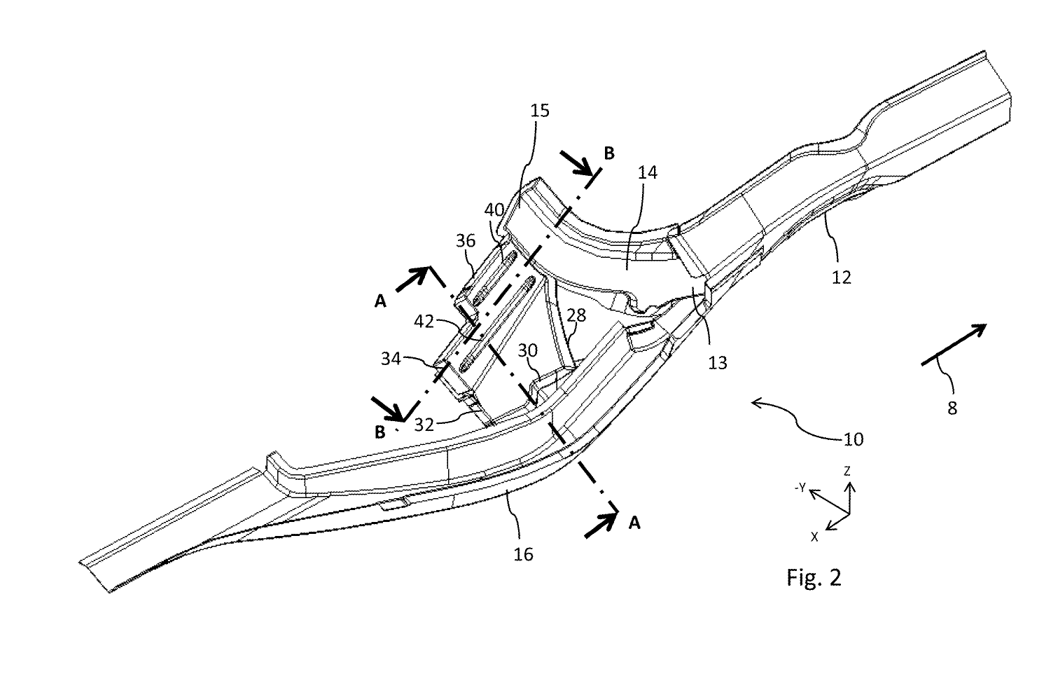

The remaining FIG. 2 to FIG. 8 show different illustrations of the reinforcing element 18 in the form of a stamped sheet metal component in its installation position on the car body 10. The reinforcing element 18 furthermore features a plurality of mounting flange sections 26, 28, 30, 32, 34, 36, 37 that partly transform directly into one another and make it possible to mount the reinforcing element 18 on adjoining components of the car body in order to structurally reinforce said components and to increase the torsional rigidity of the car body in the dashboard area.

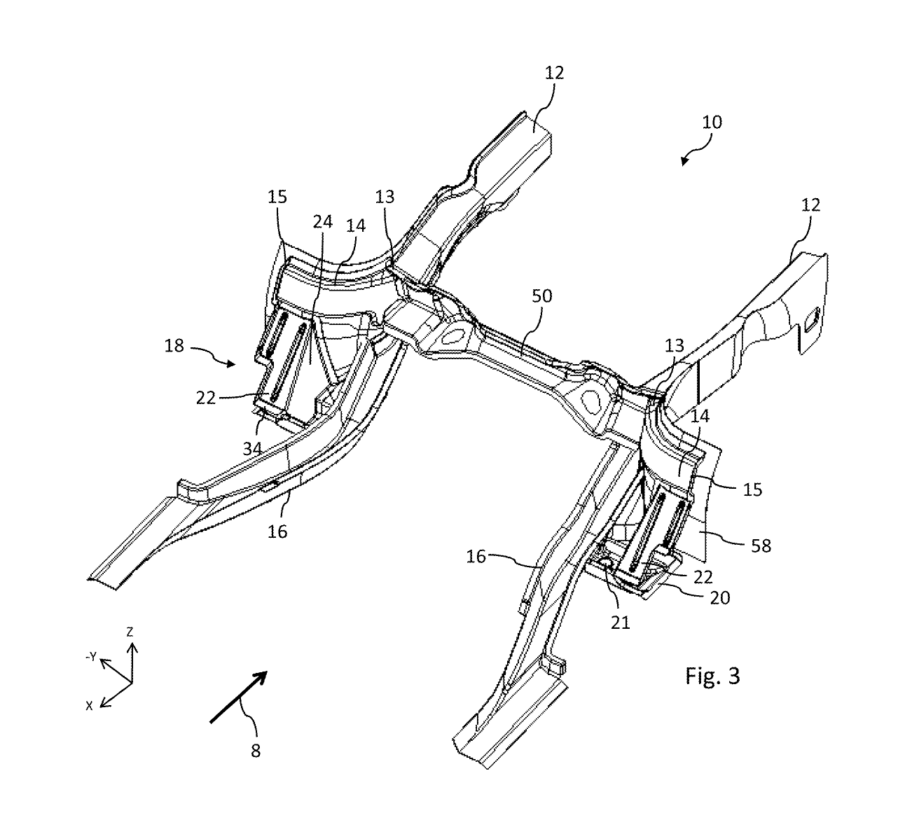

It is proposed, in particular, that the second reinforcing element 18 downwardly supports an end section 15 of a first reinforcing element 14 that protrudes outward in the lateral direction (y) of the vehicle toward a cross member structure 20 on the side of the floor as illustrated, for example, in FIG. 3. In this case, the first reinforcing element 14 preferably acts as a support for a front longitudinal beam 12 of the car body that transforms into a dashboard cross member 50 extending in the lateral direction of the vehicle and into a front frame extension 16, particularly in the region, in which it is connected to a dashboard that is not explicitly illustrated in the figures. The front longitudinal beam 12 can be supported on a lateral dashboard, as well as on the wheel housing sheet 58, by means of the outwardly protruding reinforcing element 14. Similar to the first reinforcing element 14, the front longitudinal beam 12 may consist of a sheet metal profile of C-shaped cross section.

The front end section 13 of the reinforcing element 14 which faces the front longitudinal beam 12 preferably corresponds to the cross-sectional profile of the longitudinal beam 12 in this case in order to form the largest overlapping region possible and to thusly produce a structurally rigid connection between the longitudinal beam 12 and the reinforcing element 14. According to FIG. 3, the first reinforcing element 14 is curved outward in accordance with the shape of the wheel housing sheet 58 and has a correspondingly large curvature radius that is particularly suitable for deflecting and transmitting externally acting impact or deformation forces with a comparatively small sheet metal thickness.

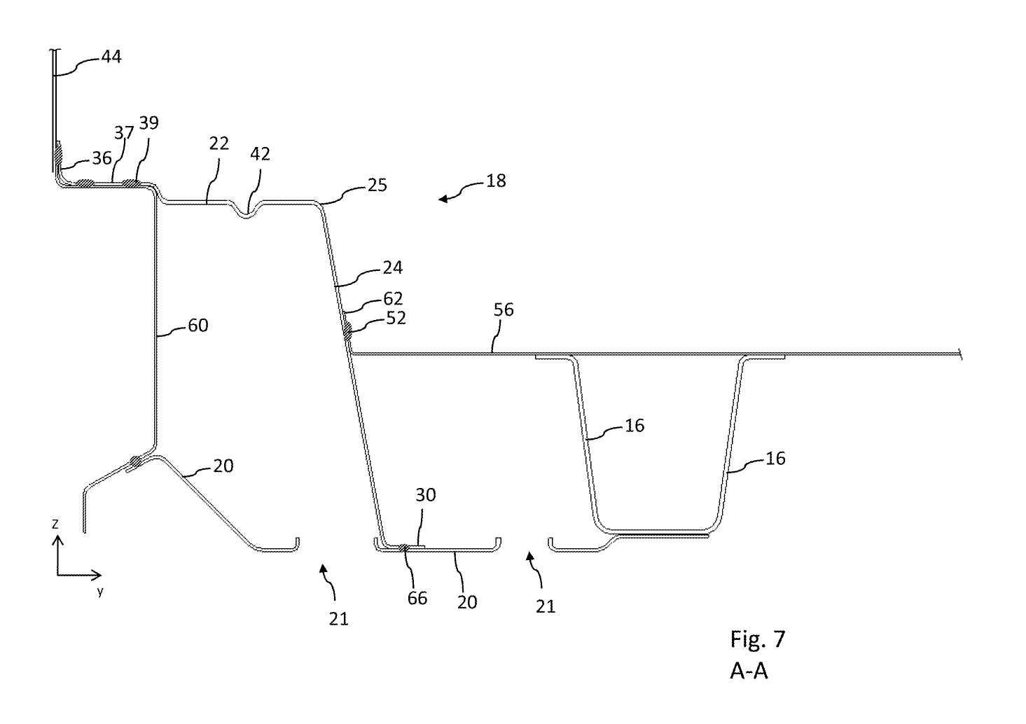

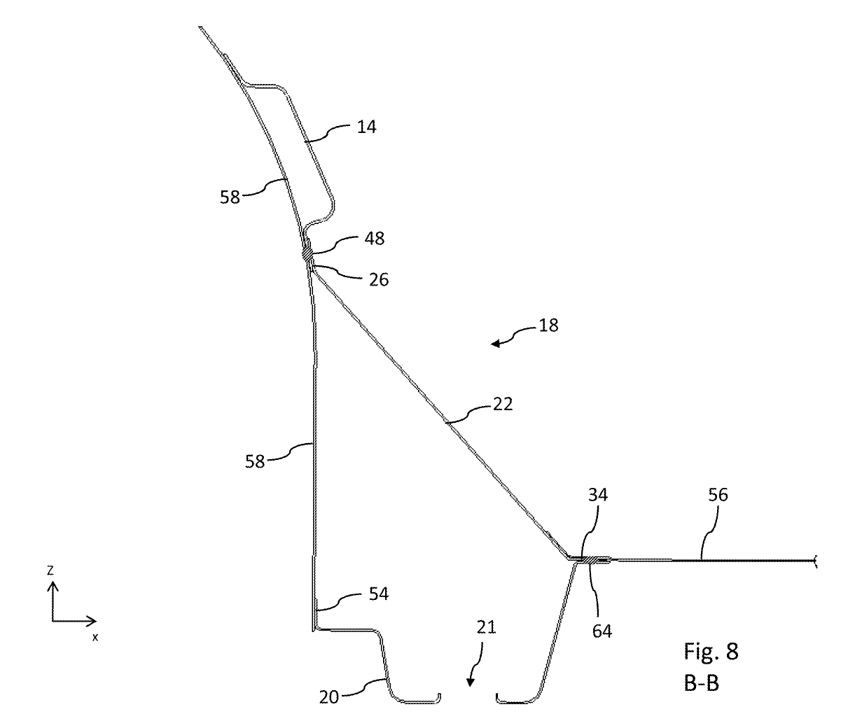

FIG. 2 furthermore shows that the front longitudinal beam 12 transforms, referred to the longitudinal direction (x) of the vehicle, into the front frame extension 16 that extends obliquely downward and also has a C-shaped profile, wherein said front frame extension is closed by a floor sheet 56 in the cross section illustrated in FIG. 7. The first reinforcing element 14, in contrast, forms a horizontal extension of the front longitudinal beam 12 that protrudes outward in the lateral direction (y) of the vehicle such that the outwardly protruding free end section 15 of the first reinforcing element 14 has a height offset referred to the front frame extension 16 and the floor sheet 56 as illustrated in the cross section in FIG. 8.

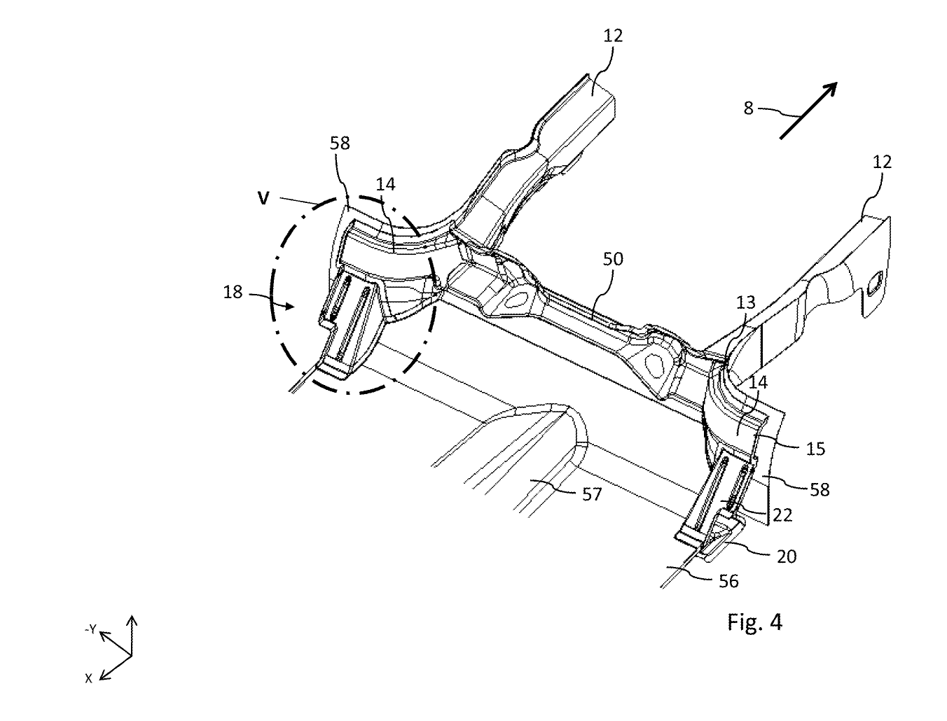

The second reinforcing element 18 is provided in order to bridge this height offset. It primarily serves for supporting the outwardly protruding free end section 15 of the first reinforcing element 14 downward, particularly toward the floor structure of the car body that features a lateral sill board, especially an inner sill board sheet 60, a floor sheet 56 and a cross member bracing 20 on the side of the floor, e.g., of the type illustrated in FIG. 3. The floor sheet 56 shown in FIG. 4 furthermore features an about centrally arranged center tunnel 37 that extends in the longitudinal direction of the vehicle.

The oblique arrangement of the surface section 22 of the second reinforcing element 18 referred to the longitudinal direction (x) of the vehicle and the vertical direction (z) of the vehicle is illustrated in the cross section B-B in FIG. 8. In the upper region, the surface section 22 borders on a lower connecting flange of the first reinforcing element 14 or on the wheel arch sheet 58 with a connecting flange section 26. The surface section 22 is downwardly supported on the floor sheet 56 by means of a connecting flange 34, wherein said floor sheet simultaneously acts as a closing sheet for the profile of the front frame extension 16 as illustrated in the cross section A-A in FIG. 7.

The cross section in FIG. 7 furthermore shows the folding or bending line 25, at which the two essentially plane surface sections 22, 24 of the reinforcing element 18 transform into one another. FIG. 7 furthermore shows that the lateral surface section 24 of the reinforcing element 18 is directly supported on a cross member structure 20 of the floor structure by means of a lower connecting flange section 30. This cross member structure 20 extends in essentially the lateral direction (y) of the vehicle and, according to FIG. 7, features two main receptacle bores 21 that serve for accommodating the car body on a support structure during the car body fabrication process. The cross member bracing 20 in the form of a sheet metal part outwardly borders on and is connected to the inner side of an inner sill board sheet 60, for example, by means of a spot weld, namely with its left end section in FIG. 7. The bottom flange 30 of the reinforcing element 18 is similarly connected to the sheet metal structure 20 by means of a spot weld 66 or a welding seam. The floor sheet 56 features an outwardly protruding mounting flange 62 that faces the reinforcing element 18 and to which the floor sheet 56 may be connected, e.g., in the region of one or more spot welds 52.

FIG. 7 furthermore shows that the reinforcing element 18 is also downwardly supported on the upper side of the inner sill board sheet 60 with an outer, lower supporting flange 37 and connected to this inner sill board sheet, e.g., by means of a joint in the form of a spot weld 39. Another mounting flange 36 is provided laterally, namely such that it upwardly borders on the flange section 32 in FIG. 1, and makes it possible to mount the reinforcing element 18 on a lateral dashboard sheet 44 that is not illustrated in greater detail in the figures.

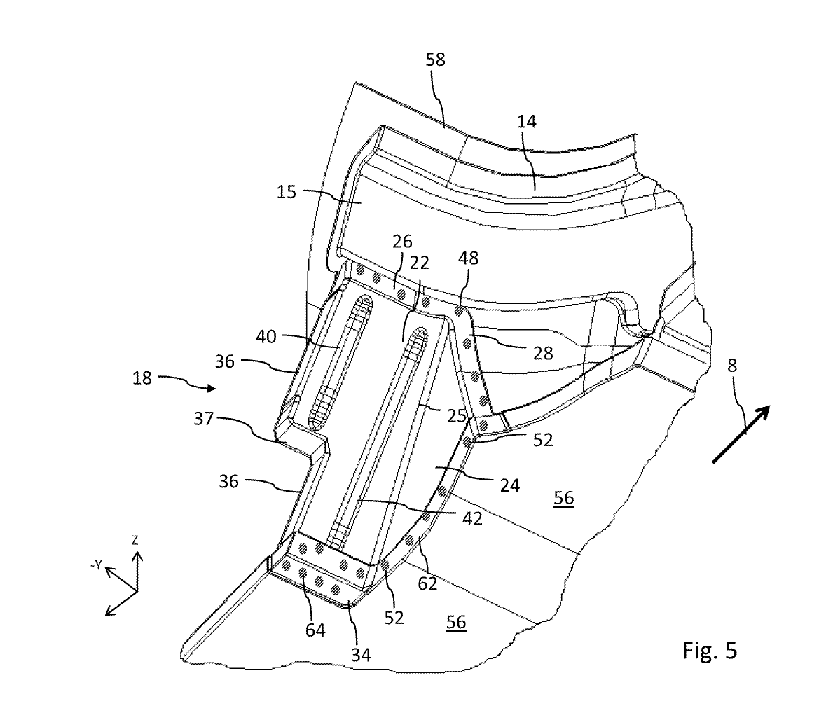

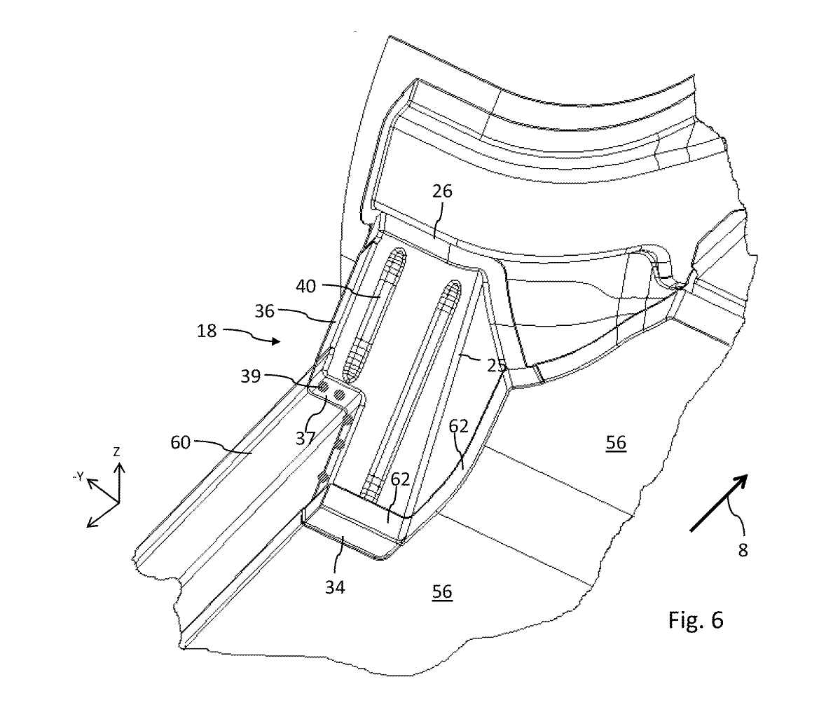

FIG. 5 and FIG. 6 furthermore show that the outer free end section 15 of the first reinforcing element 14 also features a front mounting flange that is about positioned in alignment with the mounting flange 36 and makes it possible to likewise mount the upper, first reinforcing element 14 on a lateral dashboard sheet 44.

FIG. 5 also shows a plurality of individual spot welds 48, 52, 64 that are merely illustrated in an exemplary fashion. The spot welds 48 connect the upper and lateral flange sections 26, 28 of the reinforcing element 18 to the wheel housing sheet 58 and to a lower mounting flange of the first reinforcing element 14 while the mounting points 52 are provided in the region of an elevated flange section 62 of the floor sheet 56 in order to laterally mount the floor sheet on the surface section 24. The spot welds 64 serve for connecting the lower mounting flange 34 of the reinforcing element 18 to the floor sheet 56, as well as to a mounting flange of the obliquely extending support structure 20 on the side of the floor which borders on the floor sheet 56 from below. On the other end, this cross member structure 20 is connected to the wheel arch sheet 58 by means of an elevated mounting flange 54 as illustrated, for example, in FIG. 8.

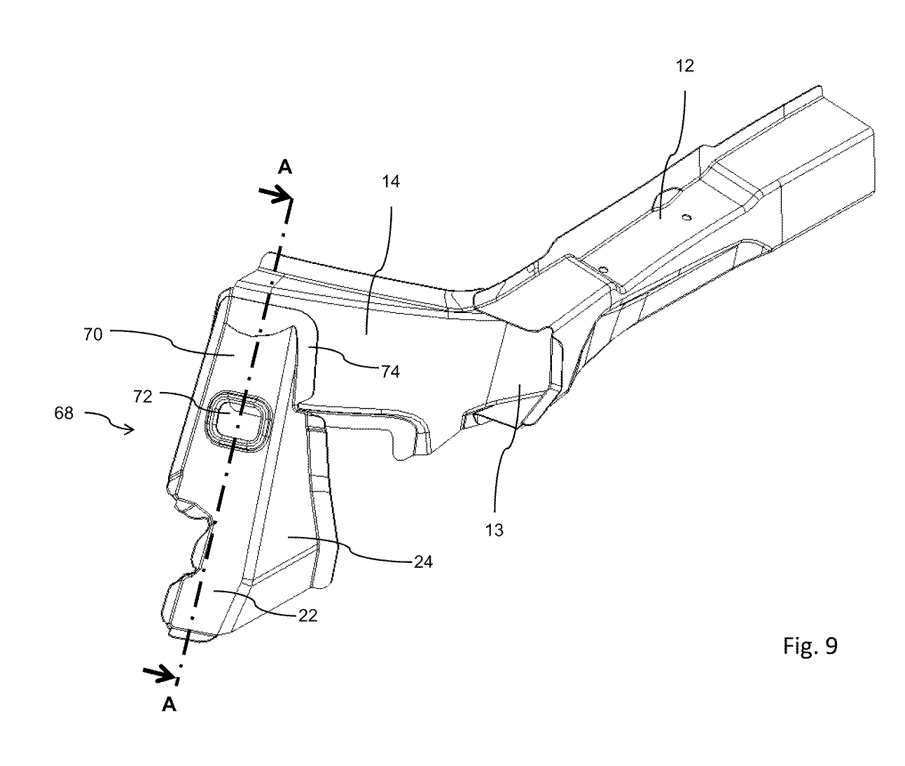

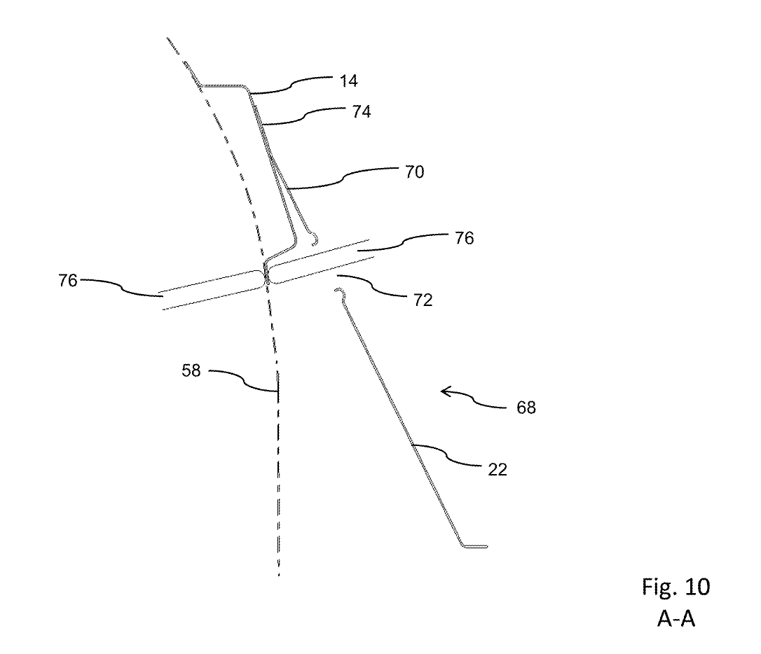

FIG. 9 and FIG. 10 show an alternative embodiment of the second reinforcing element 68. In contrast to the reinforcing element 18 illustrated in FIGS. 1 to 8, this reinforcing element features an extension in the form of a projection of the surface section 22 that extends upward in the vertical direction of the vehicle and by means of which the second reinforcing element 68 is at least sectionally positioned on the C-profile of the first reinforcing element 14. In this way, the mutual connection and support of the two reinforcing elements 14 and 68 can be improved. The overlapping profile arrangement, in particular, makes it possible to achieve an improved downward support of the first reinforcing element similar to that of a cross member.

In the region of its extension 70, the second reinforcing element 68 features a through-opening 72 for assembly purposes at the height of a lower flange section of the first reinforcing element 14, wherein a connecting or assembling means 76 such as, e.g., a welding tool can be inserted into said through-opening in order to structurally connect, e.g., the first reinforcing element 14 to the wheel housing sheet 58 situated thereunder. The upwardly protruding extension segment 70 of the second reinforcing element 68 features a largely peripheral flange section 74 in order to form the largest connecting and supporting surface possible with the first reinforcing element.

All in all, the support of the first reinforcing element 14 realized by means of the second reinforcing element 18, 68 makes it possible to reduce the sheet metal thickness of the remaining car body components and panels such that the overall weight of the car body 10 can be reduced. Furthermore, the second reinforcing element 18, in particular, is adapted to the adjoining car body components such as the first reinforcing element 14, the wheel housing sheet 58, the floor sheet 56, the cross member structure 20, an inner sill board sheet 60 and/or a lateral dashboard sheet 44 with respect to its outer contours in such a way that an optimized structural node between the inner sill board profile and the front frame structure or longitudinal beam structure of the car body can be created. This makes it possible to increase the torsional rigidity of the car body and to correspondingly improve, in particular, the intrusion behavior of the car body during a lateral impact.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A car body, comprising:
a front longitudinal beam that extends in essentially a longitudinal direction of a vehicle;
a first reinforcing element that borders the front longitudinal beam in the longitudinal direction;
an end section that faces away from the front longitudinal beam; and
a second reinforcing element that supports the end section on a floor structure.

2. The car body according to claim 1, wherein the first reinforcing element essentially extends in the longitudinal direction of the vehicle in a region of the end section that faces the front longitudinal beam and essentially in a lateral direction of the vehicle in the region of the end section that faces away from the front longitudinal beam and faces the second reinforcing element.

3. The car body according to claim 1, wherein the first reinforcing element extends outward in a lateral direction of the vehicle with the end section that faces away from the front longitudinal beam.

4. The car body according to claim 1, wherein the first reinforcing element is configured to curve outward in a lateral direction of the vehicle in accordance with a contour of a wheel housing sheet.

5. The car body according to claim 1, wherein the second reinforcing element is downwardly supported in a vertical direction of the vehicle.

6. The car body according to claim 1, wherein the second reinforcing element is outwardly supported in a lateral direction of the vehicle on a lateral sill board.

7. The car body according to claim 6, wherein the front longitudinal beam transforms into an oblique and downwardly extending front frame extension opposite to a driving direction of the vehicle.

8. The car body according to claim 7,
wherein the second reinforcing element is supported in a vertical direction of the vehicle on a cross member on the side of a floor with a lower end section, and
wherein the cross member essentially extends in the lateral direction of the vehicle between the lateral sill board and the front frame extension.

9. The car body according to claim 8, wherein the first reinforcing element and the second reinforcing element are configured to form a coherent frame structure with the front longitudinal beam, the front frame extension, and the cross member on the side of the floor.

10. The car body according to claim 1, wherein the second reinforcing element comprises a surface section in a form of a resting platform that is supported on a floor sheet on one end and extends obliquely upward in a vertical direction of the vehicle and obliquely forward in the longitudinal direction of the vehicle from the floor sheet.

11. The car body according to claim 10, wherein the surface section of the second reinforcing element is the resting platform that borders on an underside of the first reinforcing element with the end section that faces away from the floor sheet.

12. The car body according to claim 10, wherein the surface section is a lifting platform that comprises a structure-reinforcing bead.

13. The car body according to claim 1, wherein the second reinforcing element comprises two surface sections that are essentially realized plane and aligned angular to one another.

14. The car body according to claim 1, wherein the second reinforcing element comprises a flange section along an outer circumference for a connection to an adjoining car body component.

15. The car body according to claim 1, wherein the second reinforcing element comprises a plurality of flange sections along an outer circumference for connection of a plurality of adjoining car body components.

16. The car body according to claim 1, wherein the second reinforcing element is at least sectionally arranged to overlap the first reinforcing element in the longitudinal direction of the vehicle.

17. The car body according to claim 1, wherein the second reinforcing element is at least sectionally arranged to overlap the first reinforcing element in a vertical direction of the vehicle.
